(19) United States
(12) Patent Application Publication
(10) Pub. No.: US 2015/0193139 A1
(43) Pub. Date: Jul. 9, 2015

(54) TOUCHSCREEN DEVICE OPERATION

(71) Applicant: Viktor Kaptelinin, Hörnefors (SE)

(72) Inventor: Viktor Kaptelinin, Hörnefors (SE)

(21) Appl. No.: 14/147,501

(22) Filed: Jan. 4, 2014

(51) Int. Cl. G06F 3/0488; G06F 3/044

(52) U.S. Cl. CPC G06F 3/04883; G06F 3/044

(57) ABSTRACT

The invention discloses a method and apparatus for executing predetermined device functions on devices having touch-sensitive displays. The user executes a certain function by first moving the point of contact of a finger or stylus with a touch-sensitive display generally away from the initial points of contact, and then move the point of contact back toward the initial point of contact. According to some embodiments, the invention is implemented to more efficiently unlock user interfaces of computer devices having touch-sensitive displays.

### CROSS-REFERENCE TO RELATED APPLICATIONS

Provisional Patent Application of Viktor Kaptelinin, Ser. No. 61/748,738 filed Jan. 3, 2013

### FEDERALLY SPONSORED RESEARCH

Not Applicable

### 1. BACKGROUND OF THE INVENTION

The invention relates to user interfaces of computing devices having touch-sensitive displays (thereafter “touchscreen devices”).

User interfaces of touchscreen devices typically comprise various screen objects, such as icons, sliders, or hyperlinks. FIG. 1 shows a simplified example of a touchscreen device 100 having a touch-sensitive display 106. Display 106 shows a clock 108 and application icons 110. Some screen objects are non-actable, such as clock 108: they do not respond to user's physical input. Other screen objects, such as application icons 110, are actable: they respond to user's physical input, such as tapping, by executing certain predefined functions (for instance, opening a certain application). There are different types of actable objects, which can execute different functions in response to different user actions. For instance, the user can apply a tapping action to a hyperlink to display new content or apply a “pinching” action to an image to resize it. Users typically operate actable screen objects by employing fingers, styluses, other elongated objects, or combinations of the above. Such display control means in general are schematically represented in FIG. 1a as a pointed object 112.

Potential problem with touchscreen devices, especially mobile technologies such as smartphones and tablet computers, is accidental execution of undesirable functions. If a multi-touch gesture is imprecise in terms of space or timing, a wrong function can be invoked. In addition, there can be negative consequences for the user if a device accidentally gets in contact with objects in the environment, which often happens to mobile technologies.

A partial solution to the problem of accidental execution of undesirable functions is provided by user interface lock methods. Touchscreen devices are often being locked when a device is not in active use. When the user interface of a device is in a lock state, some or all touch screen user interface elements responding to user's inputs are disabled. To make it possible for the user to use a locked device the device must be unlocked. Prior art discloses several methods of unlocking touch-sensitive displays. The most common methods are “swipe to unlock” (the user swipes a finger across the display) or “slide to unlock” (the user moves a screen slider with a finger to a predefined position).

Existing methods for unlocking touch-sensitive displays typically include presenting a separate “lock screen” image, different from the images displayed when a device is in an unlocked state. FIG. 1 shows an example of a sequence of steps for unlocking a device having a touch-sensitive display, known in prior art. When device 100 is in an unlock state (FIG. 1a) the user can operate on both physical and touch screen controls, such as buttons 102 and 104 and icons 110.

The device can be put in a standby mode, for instance, by pressing button 102. In this mode the display is blank (FIG. 1b). By pressing button 104 the user wakes up the device and a “lock screen” is displayed (FIG. 1c). The screen shows a clock 108 and slider 114. The top of the screen may also display a status bar (not shown in FIG. 1). When the user swipes a finger across slider 114 the slider image moves from left to right (FIG. 1d) and an unlocked screen (FIG. 1a) is displayed.

Another example of a lock screen is shown in FIG. 1e. The user can unlock the device by a freehand swiping across the display (the movement is symbolically represented by arrow 114) or applying sliding gestures to application icons 116 to directly open respective applications (the movements are symbolically represented by arrows 118).

FIG. 1 shows that images displayed in the main area (not including a status bar area or clock area) of the “locked screen” (that is, slider 112 or icons 116) are different in shape and location from images shown in the main area of an unlocked screen (e.g., icons 110).

The unlocking sequences shown in FIG. 1 are associated with potential usability problems. First, after unlocking the display the user is presented with a new screen containing a new set of screen objects, which objects have their individual shapes and locations, different from shapes and locations of the screen objects displayed on a “lock screen”. Therefore, after perceiving and interpreting the image of a lock screen, and performing an unlocking action, the user has to perform a new cognitive task of perceiving and interpreting the image of an unlock screen, which may require additional time and effort.

Second, the methods illustrated by FIG. 1 do not allow the user to position a finger or stylus in an arbitrary location of the display in the end an unlocking gesture. The unlocking gestures end on the edge of a display (“swipe to unlock”) or in a predefined location (“slide to unlock”). Therefore, after performing an unlocking gesture user's finger needs to be repositioned if the user wishes to activate with the finger a user element shown on the unlock display, for instance, if the user wants to touch an application icon. Such a repositioning may take additional time and effort, as well.

Prior art in the area of creating touch sensitive displays does not successfully address the problem of accidental execution of undesirable functions. Existing interface lock methods only provide a partial solution; they do not work when an interface is unlocked. In addition, they can be argued to suffer from certain usability problems. The present invention addresses the above limitation of existing user interfaces of touchscreen devices by teaching a novel method of operating touch-sensitive displays, which is intended to make user interaction with such displays both safe and convenient. In particular, the method can be used to enable a more efficient transition of the user interface of a computing device from a locked state to an unlocked state.

### 2. SUMMARY OF THE INVENTION

In some embodiments a three-stage method of executing a predetermined function on an electronic device having at least a touch-sensitive display, a processor, and a memory storage, which storage can be integrated with said processor, includes the following method steps:
at the first stage, detecting, through machine-comprised means, a contact between a user-controlled display operating means, such as a finger or a stylus, and a touch-sensitive display, and if such a contact is detected, then registering an initial contact point and proceeding to the second stage, and
at the second stage, if uninterrupted contact between the user-controlled means and the touch-sensitive display is maintained, then assessing, through machine-comprised means, a distance between a current contact point and the initial contact point, and
   if the distance between a current contact point and the initial contact point becomes greater than a first predetermined distance, then proceeding to the third stage, and
at the third stage, if uninterrupted contact between the user-controlled means and the touch-sensitive display is maintained, then assessing, through machine-comprised means, a distance between a current contact point and the initial contact point, and
   if the distance between a current contact point and the initial contact point becomes smaller than a second predetermined distance, then executing a predetermined device function.

In some embodiments different predetermined device functions are performed depending on the direction, trajectory, and timing of the user-controlled means movement.

In some embodiments, a predetermined device function is performed on a user interface object, which is located generally at the initial contact point.

In some embodiments highlighting visual clues are provided generally during the transition from the second method stage to the third method stage, said visual clues highlighting a display component selected from a group consisting at least of: the initial contact point, a display area located within less than the second predetermined distance from the initial contact point, and a display object located generally at the initial contact point.

In some embodiments tactile feedback is provided when the user successfully invokes a predetermined device function.

In some embodiments the predetermined device function is the function of transitioning the device from a user interface lock state to a user interface unlock state.

In some embodiments, a method of unlocking the user interface of a computing device with a touch-sensitive display includes displaying a lock screen with one or more images, said images having substantially identical locations and shapes with images of one or more actable screen objects displayed on an unlocked screen.

In some embodiments, a method of unlocking the user interface of a computing device with a touch-sensitive display includes unlocking the user interface of the device if the trajectory of an unlocking gesture generally meets a set of predefined criteria.

In some embodiments, a method of unlocking the user interface of a computing device with a touch-sensitive display includes transitioning the user interface to an initial lock state if uninterrupted contact with the display continues for more than a predetermined amount of time without transitioning to an unlock state.

In some embodiments, a method of unlocking the user interface of a computing device with a touch-sensitive display further includes the step of executing an action associated with an actable screen object generally located at the initial contact point

In some embodiments, a method of unlocking the user interface of a computing device with a touch-sensitive display includes making the preceding image disappear gradually by becoming increasingly more transparent when distance between a current contact point and the first contact point increases.

In some embodiments, a method of unlocking the user interface of a computing device with a touch-sensitive display includes detecting whether the device has a non-display control transitioning the user interface to a home screen, and if this condition is met, then selectively unlocking the control in the user interface lock state if an unlock screen displayed on the device before the device is set to a lock state is not a home screen.

In some embodiments, an apparatus according to the invention includes at least
a touch-sensitive display; and
a computer processor, and a memory storage which can be integrated with said computer processor; and
means for detecting a contact of user-controlled means, such as fingers or styluses, with the touch-sensitive display, and
means for detecting whether a continuous uninterrupted contact with the touch-sensitive display is maintained,
means for assessing a distance between a current contact point and the first contact point,
means for detecting whether the distance between the contact points becomes greater than a third predetermined distance, and then detecting whether that the distance between the contact points becomes smaller than a fourth predetermined distance,
means for executing a predetermined device function if it is detected that the distance between the contact points becomes greater than the third predetermined distance and after that the distance between the contact points becomes smaller than the fourth predetermined distance.

In some embodiments, an apparatus according to the invention includes means for executing a predetermined device function on a user interface object generally located at the initial contact point.

In some embodiments, an apparatus according to the invention includes means for executing a predetermined device function of transitioning the device from a user interface lock state to a user interface unlock state.

In some embodiments, transitioning the device from a user interface lock state to a user interface unlock state includes displaying a lock screen with one or more images, said images having substantially identical locations and shapes with images of one or more actable screen objects displayed on an unlocked screen.

In some embodiments, an apparatus according to the invention includes means for visually highlighting the initial contact point when distance between a current contact point and the initial contact point is greater than the first predetermined distance.

### 3. BRIEF DESCRIPTION OF THE DRAWINGS

FIGS. 1a-1e illustrate some prior art methods of unlocking a device with touch-sensitive display.

FIG. 2a is a simplified flow diagram illustrating some embodiments of the invention.

FIG. 2b is a simplified flow diagram illustrating some embodiments of the invention.

FIGS. 3a-3d illustrate the GUI display of a device according to some embodiments of the invention.

FIGS. 4a-4b illustrate the GUI display of a device according to some embodiments of the invention.

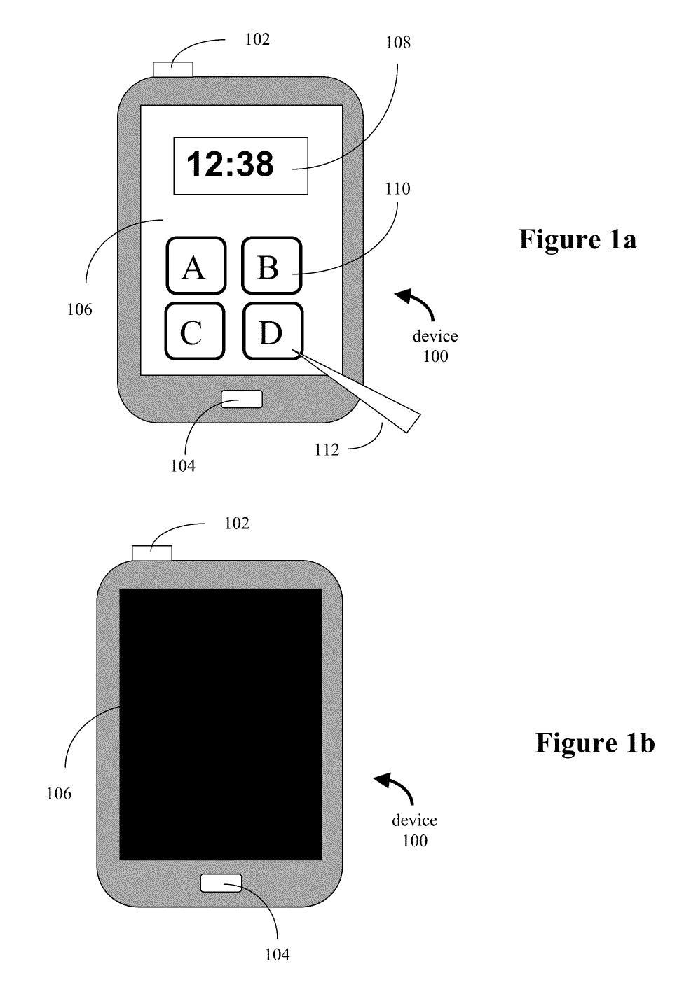

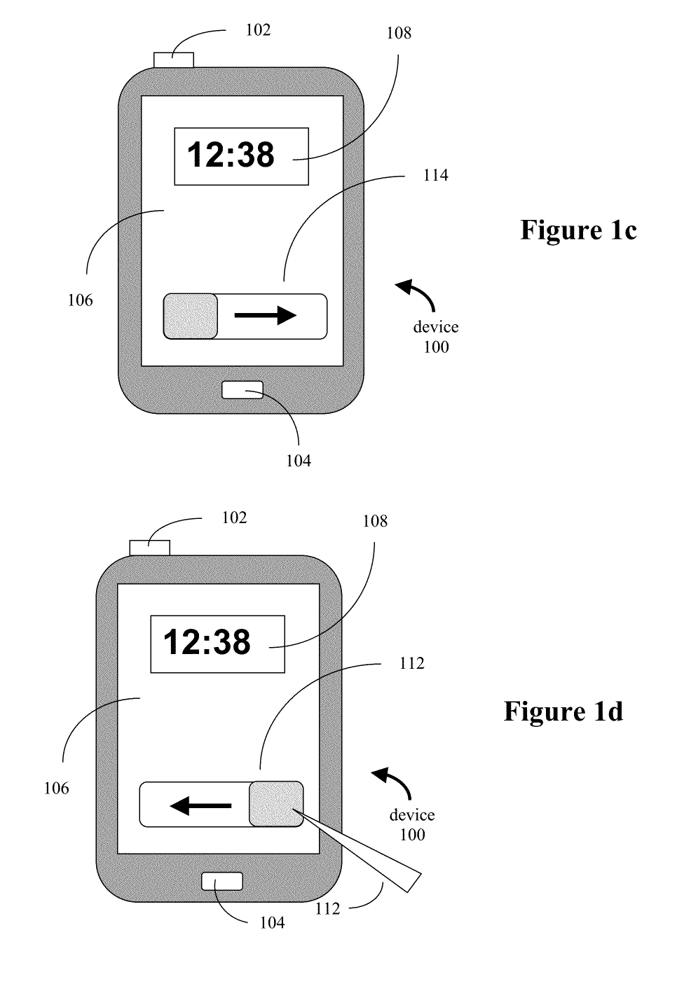

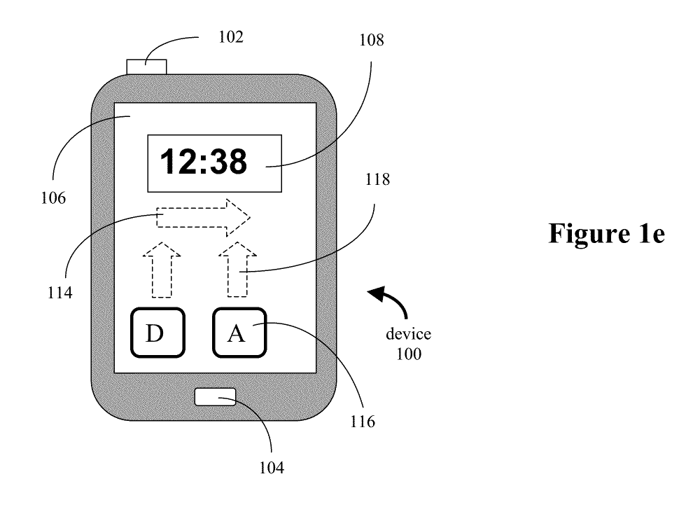

### 4. DETAILED DESCRIPTION OF THE INVENTION

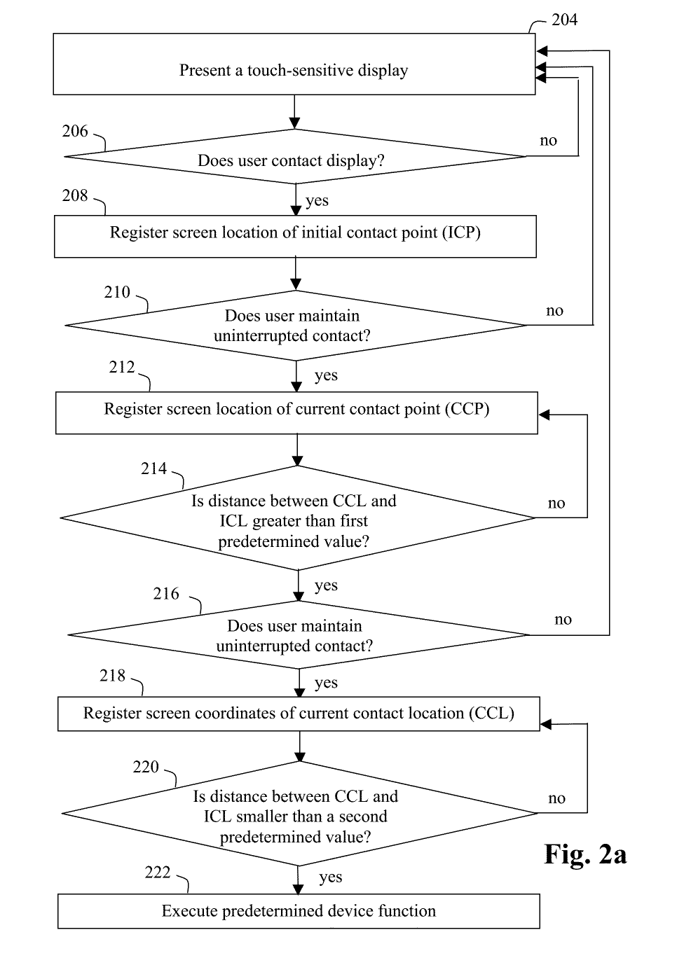

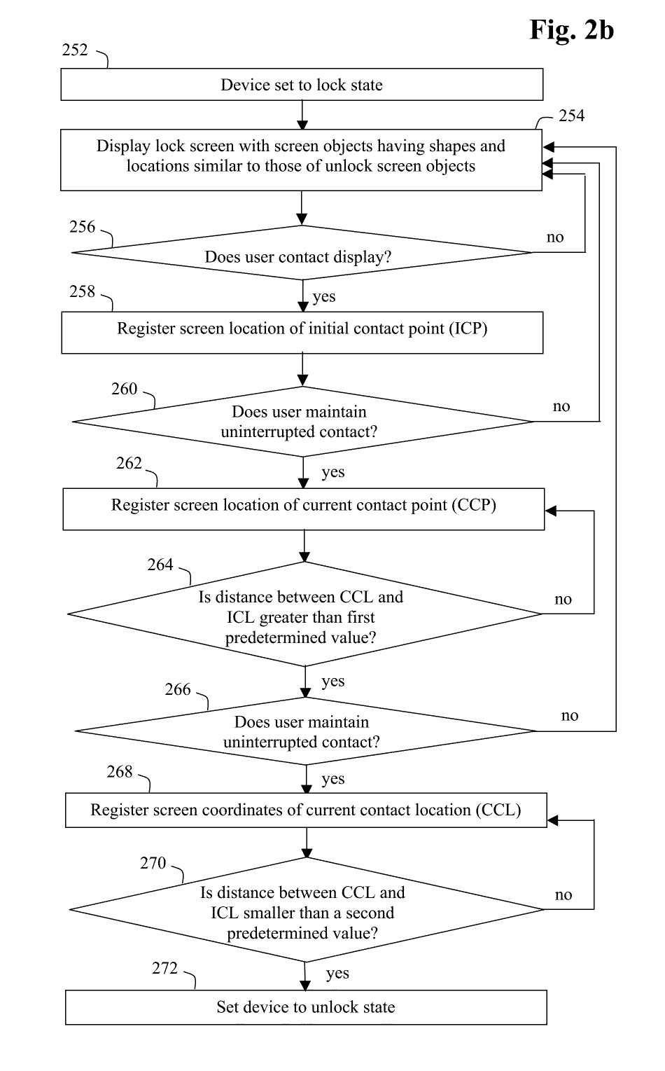

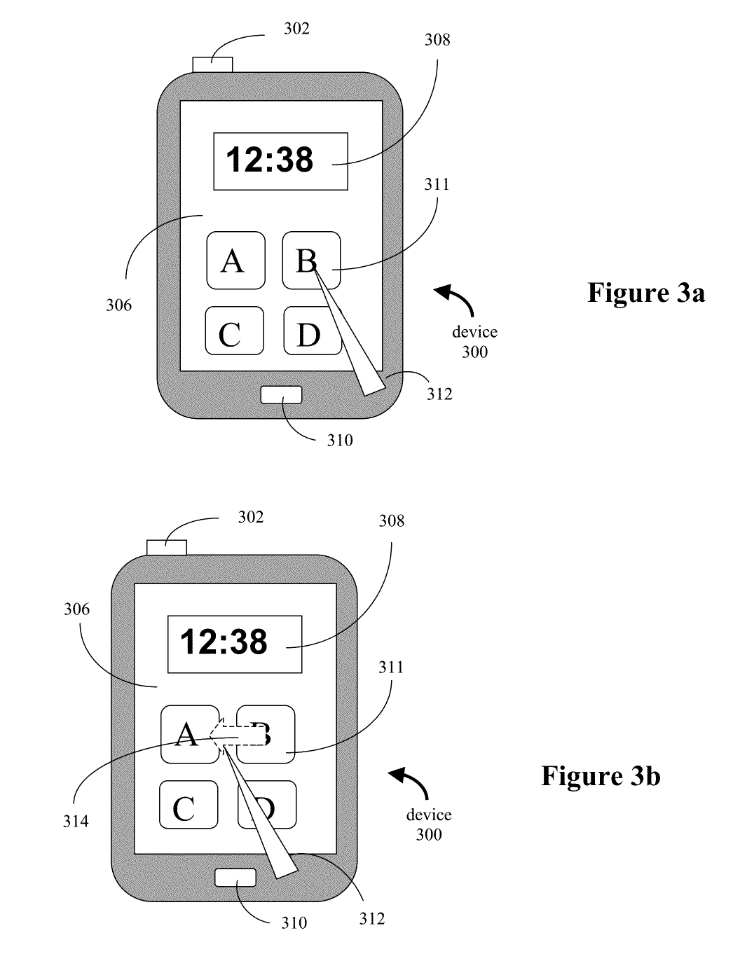

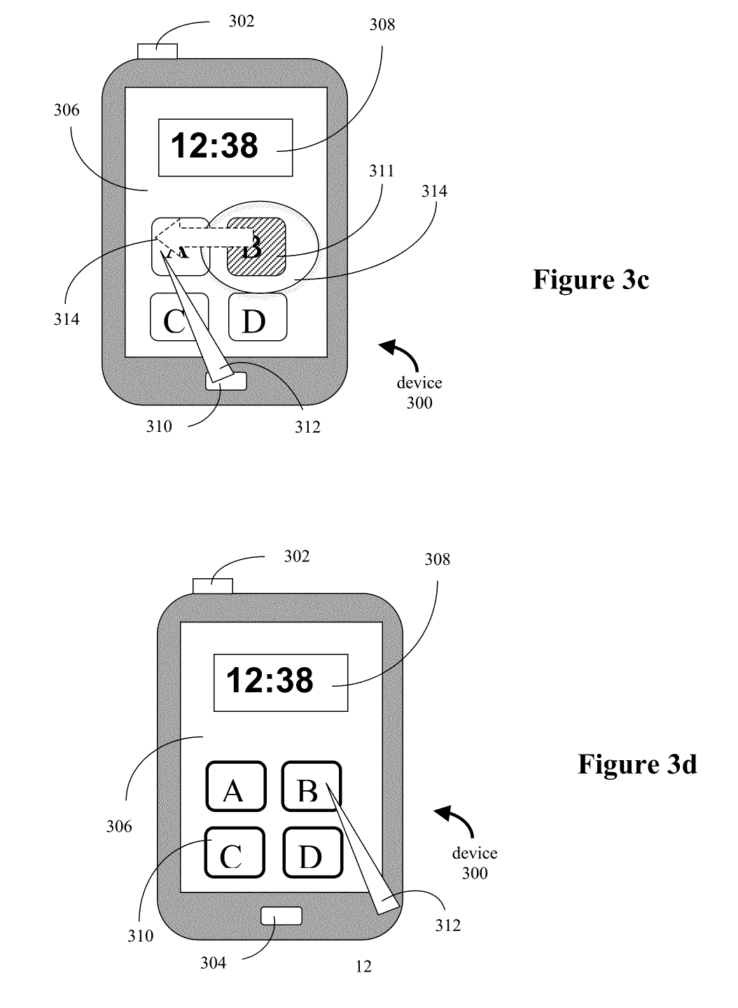

The first embodiment discloses a method and apparatus for executing a predetermined device function, such as unlocking a touch-sensitive display, by making an initial contact with the display, then moving the contact point, while maintaining a continuous contact with the display, away from the initial contact point, so that the distance between the current contact point and the initial contact point exceeds a predetermined value. During the next phase of the method a continuing contact is being maintained, and the current contact point moves generally back toward the initial contact point. The embodiment is illustrated by FIG. 2a, which is a simplified flowchart illustrating the process, and FIG. 3, which provides simplified illustrations of graphical user interface (GUI) displays. It should be noted that the figures discussed below, as well as the textual descriptions in this document are provided for illustrative purposes; the scope of the invention is not limited to the material depicted in the figures and descriptions of embodiments. In addition, it is appreciated that the figures and textual descriptions of embodiments do not present many details, obvious to those skilled in the art.

At step 204 the device is displaying a with screen objects, such as application icons. These step is illustrated by FIG. 3a.

The next step of the method, as shown in FIG. 2a, is monitoring whether the user makes contact with the display (206). If a contact is detected, the location (e.g., screen coordinates) of the initial contact point is stored in memory (208). If the user maintains uninterrupted contact with the display (210), while changing the current contact point may by moving the touchscreen contact means, such as finger or stylus (shown in FIG. 3 as element 312), the screen location of the current contact point is registered (212) and the distance between the current and initial contact points is calculated. If the distance exceeds a predetermined value (214) the method moves to the next phase. As during the previous phase, it is checked whether the user maintains uninterrupted contact with the display (216) and the screen location of the current contact point is registered (218). However, at this phase the exit condition is that the distance between the current and initial contact points is smaller than a second predetermined value (220). If this condition is met, a predetermined device function is executed, for instance, the system is transitioned from a user interface lock state to an unlock state (222). If, during one of the intermediate steps, uninterrupted contact with the display continues for more than a predetermined amount of time without executing the predetermined function, the user interface is transitioned to an initial state 206.

The above method steps are illustrated by FIG. 3a-3d. FIG. 3a shows a display operating object 312 (e.g., a finger or stylus) making an initial contact with display 306. FIG. 3b shows the display operating object 312 moving horizontally from right to left. The movement is symbolically represented by arrow 314. FIG. 3c shows the display operating object 312 moving farther away from the initial contact point so that the distance from the point exceeds the first predetermined distance. At this point visual clues are displayed: screen object B (311) is highlighted and a circular visual object 314 is shown to highlight the screen area generally located within the second predefined distance from the initial contact point. A potential problem associated with the present invention is that some users may find it difficult to return to the initial contact point in the end of the gesture. The clues shown in FIG. 3c address this potential problem. Other types of perceptual cues can also be provided to the user: for instance, the user can receive a tactile signal (e.g., a vibration) when successfully returning to the initial contact point. Such cues can be especially useful to visually impaired people and those users who prefer to operate a device without looking at it.

Finally, FIG. 3d shows display operating object 312 returning to the general area of the initial contact point, at this moment application icon B is about to be activated.

A version of the method, according to which the predetermined device function is transitioning from a user interface lock state to an unlock state is shown in FIG. 2b.

An advantage of the embodiment is that at the moment of the transitioning to an unlock state the user touches an actable object, which can be selected before the unlocking operation is initiated. There are several ways, in which the user can proceed to acting upon which he or she is touching when the device transitions to an unlock state:
(a) The user moves the finger or stylus away from the display and then decides whether or not to act upon the object (for instance, whether or not to tap it)
(b) The object is activated automatically at the moment of transitioning to an unlock state. In other words, it means executing an action associated with an actable screen object if the initial contact point lies within a screen area of the screen object and distance between the initial contact point and a current contact point is smaller than the second predetermined distance.
(c) The object is activated when the user lifts the finger or stylus away from the display. A variant of this option is that the user, while maintaining contact with the display, can move the finger or stylus around the display, select any actable objects by pointing to it, and activate the selected object by breaking contact with the display. In other words, it means executing an action associated with an actable screen object if the current contact point lies within a screen area of the screen object, distance between the initial contact point and a current contact point after becoming greater than the first predetermined distance at some point becomes smaller than the second predetermined distance, and the contact with the touch-sensitive display is lost/interrupted.
   Each of these options has its advantages and disadvantages. One possibility to implement them is to let the user decide which one they prefer by changing system preferences.

Before unlocking a smartphone or tablet computer having a “home screen” physical button the user may want to be able to press and activate the home button before using the method disclosed by the present invention to make sure screen object are at their familiar screen locations. Therefore, it can be advantageous to implement the invention so that unlocking the user interface of a computing device with a touch-sensitive display includes detecting whether the device has a non-display control transitioning the user interface to a home screen, and if this condition is met, then selectively unlocking the control in the user interface lock state if an unlock screen displayed on the device before the device is set to a lock state is not a home screen.

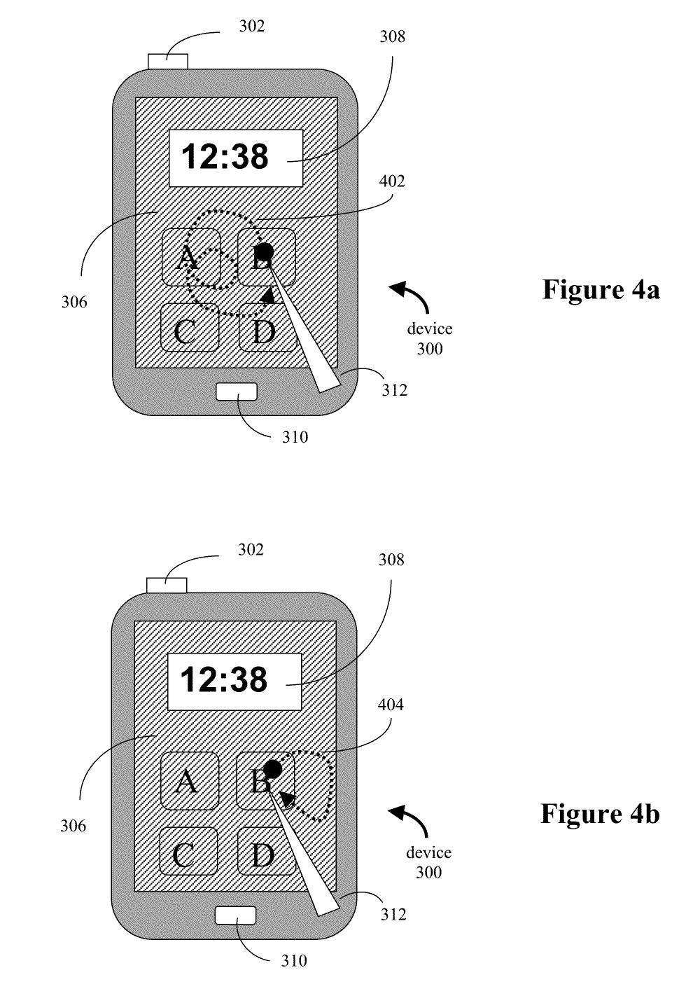

The general method disclosed by the present invention, that is, moving a contact point first away from the initial contact location, and then back to the initial contact location, can be implemented in a variety of ways. For instance, different types of device functions (opening, sharing, moving, and so forth) can be executed on the same object depending on the direction of the movement of a finger or stylus (e.g., up/down, down/up, or left/right). In addition, it opens up a possibility for implementing gestural passwords when unlocking touchscreen user interfaces: a device can be designed in such a way that transitioning to an unlock state can only be accomplished if the trajectory of unlocking gesture meets certain criteria. For instance, the overall pattern and internal elements of a unlocking gesture could be predefined and should be reproduced in order for an unlocking gesture to be successful. The overall pattern of the gesture can be, for instance, generally linear (a straightforward back-and-forth gesture), circular, or triangular. Such general patterns can include various internal elements, such as loops. FIG. 4 shows two examples of complex patterns: a generally circular counter clockwise gesture with an internal counter clockwise loop (FIG. 4a) and a generally circular clockwise gesture with no internal elements (FIG. 4b).

The method disclosed in the present invention can be combined with tapping and sliding to support visually impaired users: tapping and sliding could produce voice and sound feedback about the screen objects touched by the user, without any other functions being executed, while the method disclosed in the present invention can be used to activate a selected object.

What is claimed is:

1. A three-stage method of executing a predetermined function on an electronic device having at least a touch-sensitive display, a processor, and a memory storage, which storage can be integrated with said processor, the method comprising the method steps of:
at the first stage, detecting, through machine-comprised means, a contact between a user-controlled display operating means, such as a finger or a stylus, and a touch-sensitive display, and if such a contact is detected, then registering an initial contact point and proceeding to the second stage, and
at the second stage, if uninterrupted contact between the user-controlled means and the touch-sensitive display is maintained, then assessing, through machine-comprised means, a distance between a current contact point and the initial contact point, and
if the distance between a current contact point and the initial contact point becomes greater than a first predetermined distance, then proceeding to the third stage, and
at the third stage, if uninterrupted contact between the user-controlled means and the touch-sensitive display is maintained, then assessing, through machine-comprised means, a distance between a current contact point and the initial contact point, and
if the distance between a current contact point and the initial contact point becomes smaller than a second predetermined distance, then executing a predetermined device function.

2. A method of claim 1, wherein different predetermined device functions are performed depending on the direction, trajectory, and timing of the user-controlled means movement.

3. A method of claim 1, wherein a predetermined device function is performed on a user interface object, which is located generally at the initial contact point.

4. A method of claim 1, wherein highlighting visual clues are provided generally during the transition from the second method stage to the third method stage, said visual clues highlighting a display component selected from a group consisting at least of: the initial contact point, a display area located within less than the second predetermined distance from the initial contact point, and a display object located generally at the initial contact point.

5. A method of claim 1, wherein tactile feedback is provided when the user successfully invokes a predetermined device function.

6. A method of claim 1, wherein predetermined device function is the function of transitioning the device from a user interface lock state to a user interface unlock state.

7. A method of claim 6, wherein a lock screen displays with one or more images, said images having substantially identical locations and shapes with images of one or more actable screen objects displayed on an unlocked screen.

8. A method of claim 6, wherein unlocking the user interface of a computing device with a touch-sensitive display includes unlocking the user interface of the device if the trajectory of an unlocking gesture generally meets a set of predefined criteria.

9. A method of claim 6, wherein unlocking the user interface of a computing device with a touch-sensitive display further includes the step of executing an action associated with an actable screen object generally located at the initial contact point.

10. A method of claim 6, wherein transitioning the device from a user interface lock state to a user interface unlock state includes displaying a lock screen with one or more images, said images having substantially identical locations and shapes with images of one or more actable screen objects displayed on an unlocked screen.

11. A method of claim 6, wherein unlocking the user interface of a computing device with a touch-sensitive display includes detecting whether the device has a non-display control transitioning the user interface to a home screen, and if this condition is met, then selectively unlocking the control in the user interface lock state if an unlock screen displayed on the device before the device is set to a lock state is not a home screen.

12. An apparatus according to the invention, including at least
a touch-sensitive display; and
a computer processor, and a memory storage which can be integrated with said computer processor; and
means for detecting a contact of user-controlled means, such as fingers or styluses, with the touch-sensitive display, and
means for detecting whether a continuous uninterrupted contact with the touch-sensitive display is maintained,
means for assessing a distance between a current contact point and the first contact point,
means for detecting whether the distance between the contact points becomes greater than a third predetermined distance, and then detecting whether that the distance between the contact points becomes smaller than a fourth predetermined distance,
means for executing a predetermined device function if it is detected that the distance between the contact points becomes greater than the third predetermined distance and after that the distance between the contact points becomes smaller than the fourth predetermined distance.

13. A method of claim 12, wherein an apparatus according to the invention includes means for executing a predetermined device function on a user interface object generally located at the initial contact point.

14. A method of claim 12, wherein an apparatus according to the invention an apparatus according to the invention includes means for executing a predetermined device function of transitioning the device from a user interface lock state to a user interface unlock state.

15. A method of claim 12, wherein an apparatus according to the invention includes means for visually highlighting the initial contact point when distance between a current contact point and the initial contact point is greater than the first predetermined distance.
